(19) United States
(12) Patent Application Publication
(10) Pub. No.: US 2014/0236667 A1
(43) Pub. Date: Aug. 21, 2014

(54) ESTIMATING, LEARNING, AND ENHANCING PROJECT RISK

(71) Applicant: International Business Machines Corporation, Armonk, NY (US)

(72) Inventors: WESLEY M. GIFFORD, New Canaan, CT (US); Anshul Sheopuri, White Plains, NY (US); Rose M. Williams, Wappinger Falls, NY (US)

(73) Assignee: International Business Machines Corporation, Armonk, NY (US)

(21) Appl. No.: 13/969,804

(22) Filed: Aug. 19, 2013

Related U.S. Application Data
(63) Continuation of application No. 13/770,654, filed on Feb. 19, 2013.

(51) Int. Cl. G06Q 10/06

(52) U.S. Cl. CPC G06Q 10/0635
USPC 705/7.28

(57) ABSTRACT

Ranking a plurality of objects includes obtaining an initial set of data relating to the objects, generating an initial set of estimates based on the initial set of data, wherein the initial set of estimates includes, for each of the objects, an initial estimated change in performance and an initial estimated likelihood of decline in the performance, incrementally and dynamically refining the initial set of estimates in accordance with a new set of data from new data sources and relating to the objects to produce a refined set of estimates, wherein the refined set of estimates includes, for each of the objects, a refined estimated change in performance and a refined estimated likelihood of decline in the performance, without modifying or replacing a system used to generate the initial set of estimates, and generating a list that ranks the objects according to the refined set of estimates.

### CROSS REFERENCE TO RELATED APPLICATIONS

This application is a continuation of U.S. patent application Ser. No. 13/770,654, filed Feb. 19, 2013, which is herein incorporated by reference in its entirety.

### BACKGROUND OF THE INVENTION

The present invention relates generally to risk estimation and relates more specifically to risk estimation for services projects with specific business constraints and requirements.

A business may have multiple projects in progress at any given time, and these projects may be distributed across multiple geographies, industries, and/or business lines. Information about these projects typically changes dynamically. For instance, the number and types of risk indicators associated with the projects evolve dynamically, and data quality also changes over time. Moreover, there is limited visibility into actions taken based on risk estimates (e.g., there may be no documentation of any discussions that supported the taking of particular actions) and limited budget for re-training and upgrades. Combined, these factors make it difficult to predict how a project will behave in the future (e.g., whether performance is likely to improve or decline and by how much). Without such informed predictions, it is difficult to identify which projects are priorities (e.g., in terms of needing more relative attention and/or resources).

### SUMMARY OF THE INVENTION

Ranking a plurality of objects includes obtaining an initial set of data relating to the objects, generating an initial set of estimates based on the initial set of data, wherein the initial set of estimates includes, for each of the objects, an initial estimated change in performance and an initial estimated likelihood of decline in the performance, incrementally and dynamically refining the initial set of estimates in accordance with a new set of data from a new data source and relating to the objects to produce a refined set of estimates, wherein the refined set of estimates includes, for each of the objects, a refined estimated change in performance and a refined estimated likelihood of decline in the performance, wherein the refining is performed without modifying or replacing a system used to generate the initial set of estimates and generating a list that ranks the objects according to the refined set of estimates. The new set of data comprises a new set of predictive elements that were not initially present when the predictive models used to generate the initial set of estimates were developed. Thus, the incremental refinement avoids completely rebuilding the predictive models and therefore minimizes costs.

In another embodiment, ranking a plurality of objects includes obtaining data relating to the plurality of objects, generating a set of estimates based on the data, wherein the set of estimates includes, for each of the plurality of objects, an estimated change in performance and an estimated likelihood of decline in the performance, generating a list that ranks the plurality of objects according to the set of estimates, and quantifying a value of the list based on a known action taken with respect to one of the plurality of objects.

In another embodiment, ranking a plurality of objects includes computing a set of estimates in accordance with a dynamically changing set of data to produce, for each of the plurality of objects, an estimated change in performance and an estimated likelihood of decline in the performance and generating a list that ranks the plurality of objects according to the set of estimates, wherein the list ranks the plurality of objects such that those of the plurality of objects having an estimated decline in performance and an estimated low likelihood of improvement in performance are ranked more highly than those of the plurality of objects having an estimated increase in performance and an estimated high likelihood of improvement in performance.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating one embodiment of a system for estimating project risk, according to the present invention;

FIG. 2 is a block diagram illustrating an exemplary embodiment of one of the predictive models illustrated in FIG. 1;

FIG. 3 is a flow diagram illustrating one embodiment of a method for ranking a plurality of projects according to predicted gross profit and likelihood of gross profit decline; and

FIG. 4 is a high-level block diagram of the list generation method that is implemented using a general purpose computing device.

### DETAILED DESCRIPTION

In one embodiment, the invention is a method and apparatus for estimating, learning, and enhancing project risk. In particular, embodiments of the invention produce a prioritized list of objects based on forecasted change in performance (e.g., as measured in terms of gross profit, revenue, or the like) with confidence of improvement across multiple geographies, industries, and business lines. The prioritized list ranks the objects in terms of both magnitude of change and likelihood of decline based on a diverse set of predictors, while capturing the value of system output (i.e., the prioritized list). Although embodiments of the invention are described within the context of services projects, the methods and systems disclosed herein may be used to assess the risk associated with any portfolio of objects, including contracts, financial instruments (e.g., stocks), marketing opportunities, or any other objects for which performance may be measured in terms of revenue, profit, or customer traffic.

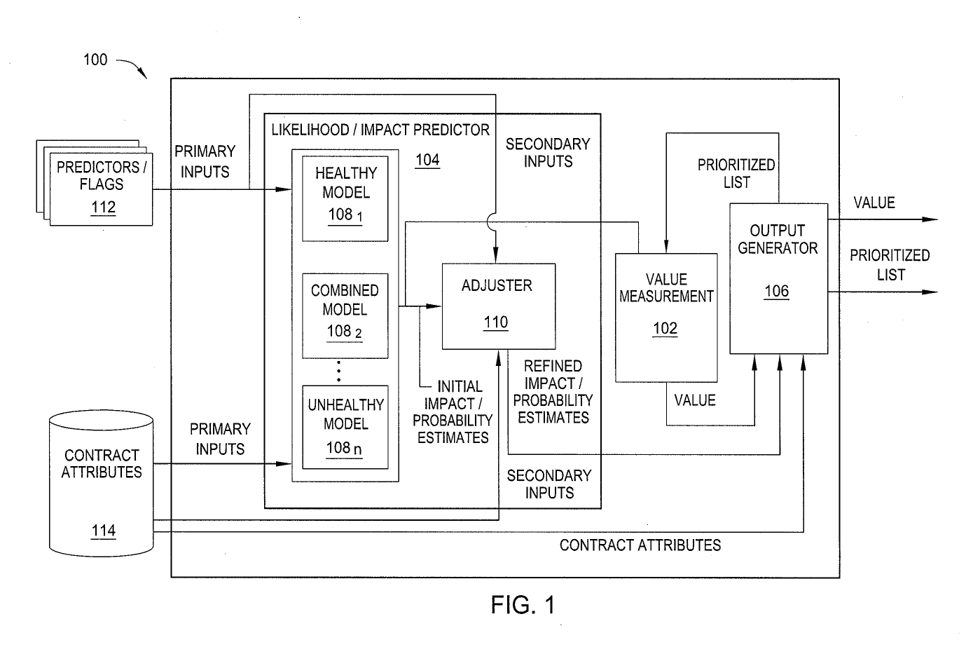

FIG. 1 is a block diagram illustrating one embodiment of a system 100 for estimating project risk, according to the present invention. The system 100 takes as inputs data about a plurality of projects (e.g., financial data, contract attributes, predictors or flags, etc.) and generates as an output a prioritized list of the projects. As illustrated, the system 100 generally comprises a value measurement module 102, a likelihood/impact predictor 104, and an output generator 106. Any of these components 102-106 may comprise a processor. In addition, the system 100 has access to a plurality of data sources or databases storing historical data, including a set of predictors/flags 112 and a contract attributes database 114.

The set of predictors/flags 112 includes data about the relative priority of or risk associated with the projects to be considered, such as standardized case ratings (e.g., Rated 1, Rated 2, . . . , etc.; High Risk, Low Risk, . . . , etc.). The contract attributes database 114 includes background and financial characteristics of the projects to be considered, such as the countries in which the projects are based, the industries to which the projects relate, or the dates on which the projects were started. Data from the set of predictors/flags 112 and the contract attributes database 114 are used as inputs by various components 102-106 of the system 100.

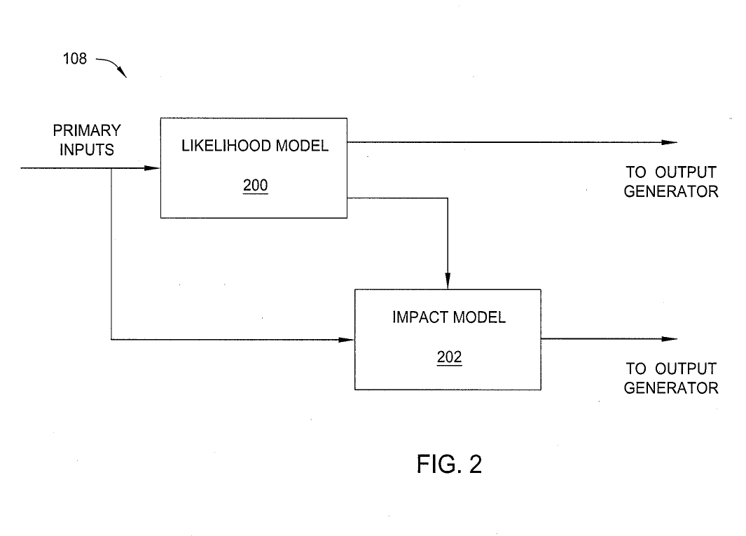

For instance, data from the set of predictors/flags 112 and the contract attributes database 114 are considered “primary inputs” to the likelihood/impact predictor 104. The likelihood/impact predictor comprises a plurality of predictive models 108₁-108ₙ (hereinafter collectively referred to as “models 108”) and an adjuster 110 (which may in turn comprise a processor). In one embodiment, the models 108 predict, based on the primary inputs: (1) the change in future gross profit for a given project; and (2) the likelihood that the given project will experience a decline in gross profit. In one embodiment, the models 108 include a plurality of models representing various project outcomes (e.g., healthy, unhealthy, combined healthy and unhealthy, etc.). The models 108 are discussed in greater detail below in connection with FIG. 2.

Data from the contract attributes database 114 is also input into the value measurement module 102. Additionally, the value measurement module 102 receives inputs from the models 108 and/or the output generator 106 (discussed in further detail below). Generally, the value measurement module 102 quantifies the value of the predictions generated by the likelihood/impact predictor 104. More specifically, the value measurement module 102 uses information about known actions that have been taken in the projects being considered to addresses the fact that model accuracy does not always reflect the efficacy of an intervening action. The known actions may be observable, partially observable, or not observable. For instance, if Project A and Project B are both initially flagged as “high risk” projects, and six months later Project A appears to be successful, it may be helpful to know if certain actions were taken in Project A but not in Project B. Thus, the value measurement module 102 considers the effects of known actions on the projects being considered so that one can better understand which actions are most beneficial and quantity the overall benefit of the system 100. The output of the value measurement module 102 (i.e., the value of the predictions, for example expressed as a cost savings or profit improvement due to actions taken because of a project's prioritization) is provided to the output generator 106.

The adjuster 110 receives the outputs of the models 108. In addition, the adjuster 110 receives the data from the set of predictors/flags 112 and the contract attributes database 114 as “secondary inputs.” The secondary inputs comprise new data sources from sources of primary inputs. The adjuster 110 uses the secondary inputs to incrementally adjust the predictions produced by the models 108 (which are based on the primary inputs) as new data becomes available (which will tend to happen often, since indicators of risk evolve dynamically and data quality also tends to change over time). Thus, the adjuster 110 in essence refines the predictions produced by the models 108 by measuring an association between the new data and the project outcome. In one embodiment, the maximum amount by which the adjuster 110 can adjust the predictions is limited. This incremental adjustment eliminates the need to rebuild the predictive models 108 as new data sources are obtained.

The output generator 106 receives as inputs the refined estimates produced by the adjuster 110. In addition, the output generator 106 also receives as inputs the data from the contract attributes database 114. Based on these inputs, the output generator 106 produces a prioritized list of the projects being considered. In particular, the projects are ranked according to their forecasted change in gross profit with confidence of gross profit improvement.

The system 100 therefore assesses a plurality of projects in order to rank the projects according to their forecasted change in gross profit with confidence of gross profit improvement. This information in turn will help project managers to better determine which projects should receive the most attention and/or resources. Knowing only the likelihood that the gross profit will decline for a given project does not allow a manager to identify projects whose decline in gross profit is likely to be even greater (and which therefore may require more resources to maintain). Similarly, knowing only the predicted amount of loss for a given project does not allow a manager to identify projects for which a loss event is more likely. Thus, the ranked list produced by the system 100 allows managers to better allocate resources among multiple projects.

FIG. 2 is a block diagram illustrating an exemplary embodiment of one of the predictive models 108 illustrated in FIG. 1. Specifically, any or all of the models 108 illustrated in FIG. 1 may be configured as illustrated in FIG. 2.

As illustrated, the model 108 is actually based on a sequential dependency of two models: a likelihood model 200 and an impact model 202. The likelihood model 200 receives the primary inputs discussed above (i.e., data from the set of predictors/flags 112 and the contract attributes database 114) and produces a first metric indicating the likelihood that a given project will experience a decline in gross profit.

The impact model 202 also receives the primary inputs as inputs. In addition, the first metric serves as an independent variable input for the impact model 202. The impact model 202 processes these inputs to produce a second metric that indicates the predicted change in future gross profit for a given project. Both the first metric and the second metric are provided to the adjuster 110 as discussed above.

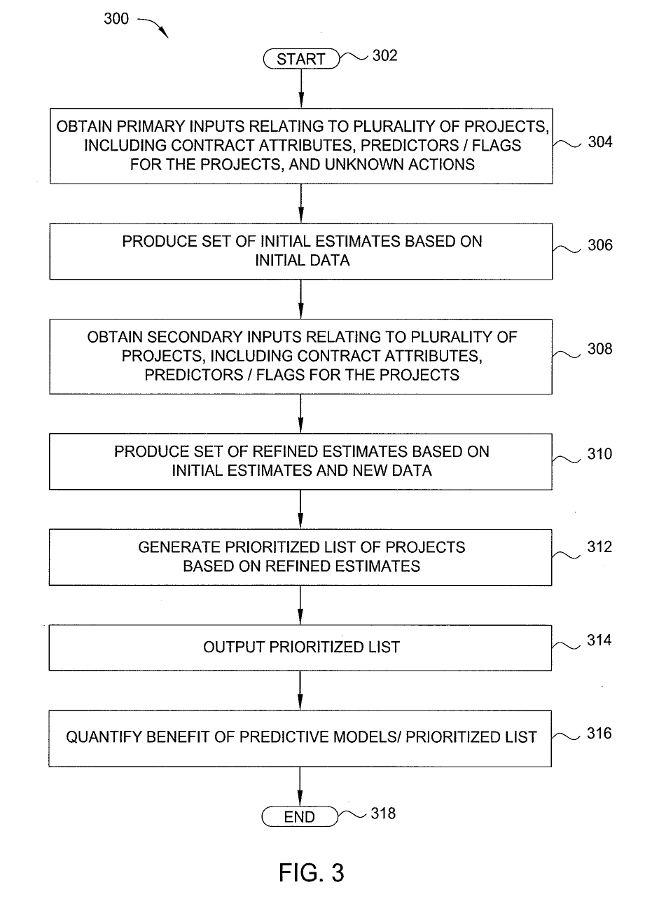

FIG. 3 is a flow diagram illustrating one embodiment of a method 300 for ranking a plurality of projects according to predicted change in gross profit and likelihood of gross profit decline. The method 300 may be performed, for example, by the system 100 illustrated in FIGS. 1 and 2. As such, reference is made in the discussion of the method 300 to various items illustrated in FIGS. 1 and 2. However, the method 300 is not limited by the configuration of the system 100 illustrated in FIGS. 1 and 2.

The method 300 begins in step 302. In step 304, the system 100 obtains primary inputs (i.e., initial data relating to the plurality of projects, including contract attributes and predictors/flags for the projects). As discussed above, the primary inputs are received from the set of predictors/flags 112 and the contract attributes database 114. The primary inputs may contain, for example, data about the relative priority of the projects (e.g., standardized case ratings) and background and financial characteristics of the projects (e.g., the countries in which the projects are based, the industries to which the projects relate, or the dates on which the projects were started). In addition to the primary inputs, the system 100 obtains information about specific actions that were taken in the plurality of projects.

In step 306, the models 108 generate a set of initial estimates based on the primary inputs received in step 304. In one embodiment, the set of initial estimates includes, for each project: (1) the estimated change in gross profit for the project; and (2) the estimated likelihood that the project will experience a decline in gross profit.

In one embodiment, the likelihood of decline in gross profit is first estimated using logistic regression. The change in gross profit is then estimated using a robust linear regression model that uses the estimated likelihood as a predictor.

In step 308, the system 100 obtains secondary inputs (i.e., new or updated data relating to the plurality of projects, including contract attributes and predictors/flags for the projects).

In step 310, the adjuster 110 produces a set of refined estimates based on the initial estimates produced in step 306 and the new data obtained in step 308. The refined estimates comprise incremental adjustments to the initial estimates based on the new data. As discussed above, in one embodiment, the maximum amount by which the adjuster 110 can adjust the initial estimates is limited.

In one embodiment, the set of refined estimates is based on an association between the new data and the project outcome. In one embodiment, the new estimate, p_{new}, of the likelihood that the project will experience a decline in gross profit is computed as:

$${p}_{new} = {p}_{old} + {\sum }_{j}^{ } {δ}_{j} {a}_{j} , {p}_{new} ∈ [ 0 , 1 ] , {a}_{j} ∈ [ - 1 , 1 ] \qquad ( EQN . 1 )$$

where p_{old} is the initial estimate of the likelihood, δⱼ is the structure mapping engine (SME)-assigned weight for the j^{th} new variable, and aⱼ is the degree of association of the j^{th} new variable with the project outcome. This association can be computed, for example, in accordance with Cramér's V (i.e., (φ_{c}) or Yule's Q.

In step 312, the output generator 106 generates a prioritized list of the projects, based on the set of refined estimates and on at least some of the primary inputs (e.g., the contract attributes). The prioritized list ranks the plurality of projects according to their forecasted change in gross profit with confidence of gross profit improvement. In one embodiment, those projects with a forecasted decline in gross profit and low likelihood of improvement in gross profit are ranked at the top of the list, while projects with a forecasted increase in gross profit and high likelihood of improvement are ranked at the bottom of the list.

In step 314, the output generator outputs the prioritized list for review (e.g., by a project manager).

In step 316, the value measurement module 102 quantifies the benefit of the predictive models 108. Quantification of the value analytics can help justify investment in such technologies. It also allows one to understand which actions are most valuable (when there is visibility into the actions taken as a result of the estimates produced by the predictive models 108). Since there tends to be limited visibility into actions, and since data quality changes over time, value measurement is often a difficult task. In one embodiment, the value measurement module 102 employs techniques based on causal inference. These techniques may, for example, characterize the interrelationships between observed quantities (e.g., project characteristics, risk factors, financial data) and unobserved quantities (e.g., unknown risks, market factors), infer distributions of outcome variables (e.g., project profitability) based on system inputs and other observed values, and compare inferred distributions under different conditions or project categories to assess the value of the predictive models 108.

The method 300 then ends in step 318. However, it will be appreciated that since new data may be generated continuously, the method 300 may also be implemented as an iterative process in which, for example, at least steps 306 and 310-316 are repeated in a loop.

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying figures that recite a determining operation or involve a decision, do not necessarily require that both branches of the determining operation be practiced. In other words, one of the branches of the determining operation can be deemed as an optional step.

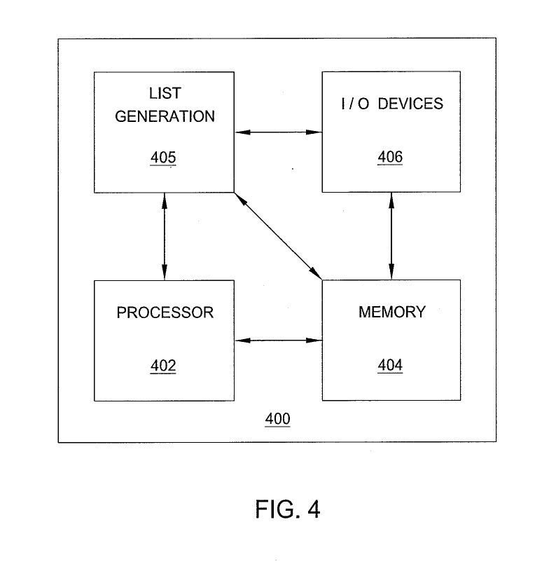

FIG. 4 is a high-level block diagram of the list generation method that is implemented using a general purpose computing device 400. The general purpose computing device 400 may comprise, for example, a portion of the system 100 illustrated in FIGS. 1 and 2. In one embodiment, a general purpose computing device 400 comprises a processor 402, a memory 404, a list generation module 405 and various input/output (I/O) devices 406 such as a display, a keyboard, a mouse, a stylus, a wireless network access card, an Ethernet interface, and the like. In one embodiment, at least one I/O device is a storage device (e.g., a disk drive, an optical disk drive, a floppy disk drive). It should be understood that the list generation module 405 can be implemented as a physical device or subsystem that is coupled to a processor through a communication channel.

Alternatively, the list generation module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the list generation module 405 for ranking a plurality of projects according to predicted gross profit and likelihood of gross profit decline, as described herein with reference to the preceding figures, can be stored on a computer readable storage medium (e.g., RAM, magnetic or optical drive or diskette, and the like).

While the foregoing is directed to embodiments of the present invention, other and further embodiments of the invention may be devised without departing from the basic scope thereof. Various embodiments presented herein, or portions thereof, may be combined to create further embodiments. Furthermore, terms such as top, side, bottom, front, back, and the like are relative or positional terms and are used with respect to the exemplary embodiments illustrated in the figures, and as such these terms may be interchangeable.

What is claimed is:

1. A system for ranking a plurality of objects, the system comprising:
a processor; and
a computer readable storage medium that stores instructions which, when executed, cause the processor to perform operations comprising:
obtaining an initial set of data relating to the plurality of objects;
generating an initial set of estimates based on the initial set of data, wherein the initial set of estimates includes, for each of the plurality of objects, an initial estimated change in performance and an initial estimated likelihood of decline in the performance;
incrementally and dynamically refining the initial set of estimates in accordance with a new set of data from a new data source and relating to the plurality of objects to produce a refined set of estimates, wherein the refined set of estimates includes, for each of the plurality of objects, a refined estimated change in performance and a refined estimated likelihood of decline in the performance, wherein the refining is performed without modifying or replacing a system used to generate the initial set of estimates; and
generating a list that ranks the plurality of objects according to the refined set of estimates.

2. The system of claim 1, wherein the plurality of objects comprises a plurality of projects.

3. The system of claim 2, wherein the plurality of projects comprises a plurality of services projects.

4. The system of claim 1, wherein the initial set of data comprises data related to relative priorities of the plurality of objects, background data related to the plurality of projects, and financial characteristics of the plurality of objects.

5. The system of claim 1, wherein the initial estimated likelihood of decline in the performance is calculated using logistic regression.

6. The system of claim 5, wherein the initial estimated change in performance is calculated using a robust linear regression model that uses the initial estimated likelihood of decline as a predictor.

7. The system of claim 1, wherein a maximum amount by which the initial set of estimates can be incrementally refined is limited.

8. The system of claim 1, wherein the new set of data comprises data related to relative priorities of the plurality of objects, background data related to the plurality of projects, and financial characteristics of the plurality of objects.

9. The system of claim 1, wherein the incrementally adjusting is based on an association between the new set of data and a set of outcomes associated with the plurality of objects.

10. The system of claim 1, wherein the list ranks the plurality of objects such that those of the plurality of objects having an estimated decline in performance and an estimated low likelihood of improvement in performance are ranked more highly than those of the plurality of objects having an estimated increase in performance and an estimated high likelihood of improvement in performance.

11. The system of claim 1, wherein the operations further comprise:
quantifying a value of the list.

12. The system of claim 11, wherein the quantifying employs a causal inference technique to infer an effect of a known action taken within respect to one of the plurality of projects on the refined estimated change in performance or the refined estimated likelihood of decline in the performance for the at least one of the plurality of projects.

13. The system of claim 12, wherein the known action is an observable action.

14. The system of claim 12, wherein the known action is a partially observable action.

15. The system of claim 12, wherein the known action is an action that is not observable.

16. The system of claim 1, wherein the performance is measured in terms of gross profit.

17. The system of claim 1, wherein the performance is measured in terms of revenue.

18. A system for ranking a plurality of objects, the system comprising:
a plurality of models for generating an initial set of estimates based on an initial set of data relating to the plurality of objects, wherein the initial set of estimates includes, for each of the plurality of objects, an initial estimated change in performance and an initial estimated likelihood of decline in the performance;
an adjuster for incrementally and dynamically refining the initial set of estimates in accordance with a new set of data from a new data source and relating to the plurality of objects to produce a refined set of estimates, wherein the refined set of estimates includes, for each of the plurality of objects, a refined estimated change in performance and a refined estimated likelihood of decline in the performance, wherein the refining is performed without modifying or replacing a system used to generate the initial set of estimates; and
an output generator for generating a list that ranks the plurality of objects according to the refined set of estimates.

19. The system of claim 18, further comprising:
a value measurement module for quantifying a value of the list based on a known action taken with respect to one of the plurality of objects.
